(19) United States
(12) Patent Application Publication
(10) Pub. No.: US 2016/0214286 A1
(43) Pub. Date: Jul. 28, 2016

(54) METHOD FOR PRODUCING A MOULDED PART BY STRUCTURAL FOAM MOULDING, MOULDED PART OF AN EXPANDED THERMOPLASTIC MATERIAL AND USES THEREFOR

(71) Applicant: COVESTRO DEUTSCHLAND AG, Leverkusen (DE)

(72) Inventors: Ulrich GROSSER, Kürten (DE); Jan HELMIG, Dormagen (DE); Thorsten SCHULZ, Leverkusen (DE); Thomas GRIMM, Pulheim (DE); Lucia WINKLER, Wermelskirchen (DE)

(73) Assignee: Covestro Deuschland AG, Leverkusen (DE)

(21) Appl. No.: 15/026,439

(22) PCT Filed: Sep. 29, 2014
(86) PCT No.: PCT/EP2014/070723

§ 371 Date: Mar. 31, 2016

(30) Foreign Application Priority Data
Oct. 2, 2013 (EP) 13187158.4

(51) Int. Cl. B29C 44/34; C08J 9/04; B29B 7/00; B29C 44/42; B29C 45/77

(52) U.S. Cl. CPC B29C 44/355; B29C 44/42; B29C 45/77; B29B 7/00; C08J 9/04; B29C 2945/76598; B29K 2101/12

(57) ABSTRACT

The invention relates to a method for producing a moulded part (50) by structural foam moulding, in which a polymer melt (18) is provided by melting a thermoplastic material, in which the polymer melt (18) is charged with a foaming agent (22) and in which the polymer melt (18) charged with the foaming agent (22) is injected under pressure into a cavity (26) of a mould (28), and so the polymer melt (18) fills the cavity (26) behind a melt front (34) running through the cavity (26), wherein the rate of injection at which the polymer melt (18) is injected into the cavity (26) of the mould (28) is set such that the internal pressure of the polymer melt (18) in the cavity (26), in a region (40) that follows a portion of the melt front (34) with a time delay of at most 0.15 seconds, is greater than the critical pressure of the foaming agent (22), at least at one point in time during the injection-moulding operation. The invention also relates to a moulded part (50) of an expanded thermoplastic material, wherein the moulded part (50) has a surface region with visual structuring formed by the expanded thermoplastic material of which the average ratio of the degrees of gloss measured in the direction of flow in relation to the degrees of gloss measured transversely to the direction of flow is below 1.9, preferably below 1.5, in particular below 1.2. The invention also relates to uses of such a moulded part.

The invention relates to a process for the production of a molding by structural foam molding, in which a plastics melt is provided by melting of a thermoplastic, in which the plastics melt is loaded with a blowing agent, and in which the plastics melt loaded with the blowing agent is injected under pressure into a cavity of a mold in such a way that the plastics melt fills the cavity behind a melt front proceeding through the cavity. The invention further relates to a molding made of a foamed thermoplastic, in particular produced by structural foam molding, preferably amenable to production by the abovementioned process. The invention further relates to uses for said molding.

The foaming of thermoplastics systems in the injection-molding process (structural foam molding) or in the extrusion process (foam extrusion) has been prior art for some decades. A distinction is drawn in principle here between chemical and physical foaming processes. In the case of chemical foaming, a defined quantity of a suitable blowing agent in granulate form is added to the thermoplastic, and by virtue of the high temperatures during the injection-molding or extrusion process reacts and liberates gases which cause foaming of the thermoplastic.

In the case of physical foaming, which is mostly used for injection processes, there are various industrial methods for adding the blowing agent. An example of a familiar method consists in introducing into the liquid plastics melt in the region of a screw used for the conveying of the plastics melt, a gas such as nitrogen or carbon dioxide in supercritical state. By virtue of specifically designed screw geometry, thorough mixing is achieved under high pressure before injection of the thermoplastic, and very uniform distribution of the gas in the plastics melt (supercritical solution). When the plastics melt passes from the screw into the cavity of the mold a significant pressure drop occurs in the plastics melt, and the supercritical gas is therefore converted to the subcritical state, and can expand to form tiny bubbles, and can thus cause foaming of the thermoplastic. The moldings thus produced have a core with a microcellular structure brought about by the tiny bubbles.

The properties of foamed thermoplastics are mostly significantly different from the properties of compact injection-molded or extruded thermoplastics. A frequent reason for the use of foaming processes is that the weight of the molding can be reduced while its volume remains the same. There can moreover be a significant improvement in specific mechanical properties based on the weight, for example in particular flexural stiffness and torsional stiffness.

Another advantage of foamed thermoplastics is that the blowing-agent-loaded plastics melt has lower viscosity than untreated plastics melts during foaming in the cavity of the mold. It is thus possible in particular to achieve better filling of moldings with long and narrow flow paths.

Foamed thermoplastics not only have the mechanical and rheological advantages mentioned but also have very good insulation behavior. With the additional weight reduction in comparison with unfoamed plastics it is therefore also possible to manufacture moldings in useful designs with high wall thicknesses and extremely good insulation properties.

A major disadvantage of foaming processes, and in particular also of structural foam molding, is that the moldings produced by these processes have very nonuniform and rough surfaces. The nonuniform surfaces of the moldings result from a very wide variety of surface defects that can occur during foaming processes. These defects are dependent on a very large number of factors, and in the current prior art are difficult to foresee. By way of example processing parameters such as injection velocity, mold temperature, gas loading, etc. exert strong influences; however, the geometry of the molding per se, for example thickness of molding, shape irregularities or fillets, wall thicknesses, abrupt changes of dimensions, etc. can also exert an enormous influence on surface defects.

Various attempts have been made with various levels of success in the prior art to conceal the surface defects on the moldings, in order to improve their appearance. In the case of foam extrusion by way of example it is possible to use an unfoamed, coextruded layer which conceals the defects of the foamed core. In the case of structural foam molding it is possible by way of example, within the cavity of the mold, to use counterpressure which prevents evolution of gas from the blowing-agent-loaded plastics melt at the melt front, so that a coherent outer layer can form. It has moreover been found that a high temperature of the mold wall has a favorable effect on the surface quality of the resultant molding. In the case of simple molding geometries moreover foils are frequently inserted into the cavity of the mold, and are then in-mold-coated with the foaming thermoplastic, and conceal the foamed surface. However, these methods for concealing surface defects are in some cases very complicated, and are sometimes only partially successful, or influence the properties of the surface of the molding.

In the prior art there is in principle a large requirement for moldings produced by the structural foam molding process, because the materials have the advantageous properties described above. However, the intention is that these moldings at the same time have a visually attractive surface, and specifically as far as possible without complicated modification of the production process.

Starting from the prior art described above, it is an object of the present invention to provide a process for the production of a molding by structural foam molding, and also to provide a molding produced by structural foam molding, where these can achieve a visually attractive surface of the molding, in particular with avoidance of the disadvantages of the prior art described above.

This object is at least to some extent achieved in the invention in a process for the production of a molding by structural foam molding, in which a plastics melt is provided by melting of a thermoplastic, in which the plastics melt is loaded with a blowing agent, and in which the plastics melt loaded with the blowing agent is injected under pressure into a cavity of a mold in such a way that the plastics melt fills the cavity behind a melt front proceeding through the cavity, in that the injection velocity at which the plastics melt is injected into the cavity of the mold is adjusted in such a way that, in a region that follows a section of the melt front with a chronological separation of at most 0.15 s, at least at one juncture during the injection procedure, the internal pressure of the plastics melt in the cavity is greater than the critical pressure of the blowing agent.

In structural foam molding, a blowing-agent-loaded plastics melt is injected under pressure into a cavity of a mold. To this end, the mold has at least one injection aperture, attached to which there is an injection apparatus for injecting the plastics melt through the injection aperture of the mold. The cavity of the mold comprises a molding region which corresponds to the negative shape of the molding to be produced, and also usually at least one feed channel, connecting the at least one injection aperture to the molding region. If there are a plurality of injection apertures there can correspondingly be a plurality of feed channels. A feed channel can also be designed as distributor channel which connects the at least one injection aperture to a plurality of sites of the molding region. The term sprue is used to describe the plastics melt that has solidified in the feed channel after injection and that is connected to the actual molding. This sprue is usually removed, for example by sawing, break-off, cutting, etc. before the further use of the molding, in order to obtain the actual molding with the desired shape. The term gate mark is used to describe the transition from a sprue to the actual molding.

The injection velocity at which the plastics melt is injected into the cavity of the mold here means the rate at which the plastics melt is conveyed to the injection aperture of the mold. By way of example a screw conveyor can be used to convey the plastics melt to the injection aperture of the mold. The screw of the screw conveyor can first convey the quantity of plastics melt required to fill the cavity in a cavity in front of the screw. During injection, the screw can then be translated forward, so that it forces the plastics melt through the injection aperture into the cavity of the mold, in the manner of a piston. The injection velocity here corresponds to the rate at which the screw is moved forward.

Since the quantity of the plastics melt conveyed to the injection aperture, for a certain translation rate of the screw, also depends on the cross section of the particular screw conveyor, the injection velocity to be set in the process described above is equipment-dependent. The injection velocity that has to be set for a certain mold can therefore depend not only on the geometry of the mold but also on the geometry of the machine which conveys the plastics melt to the injection aperture of the mold. It is then possible in each case to determine the injection velocity that has to be set for a prescribed mold, a prescribed plastics melt, and a prescribed machine for conveying the plastics melt to the injection aperture.

The internal pressure of the plastics melt means the location-dependent, local dynamic backpressure within the plastics melt. During the injection procedure, a pressure distribution dependent on the injection velocity arises in the plastics melt, and the internal pressure of the plastics melt here decreases between the injection aperture of the cavity for the introduction of the plastics melt and the melt front. The internal pressure of the plastics melt at the melt front arises by virtue of any counterpressure of the gas in the remaining, as yet unfilled cavity of the mold, and is therefore usually relatively small, in particular close to 0 bar or ambient pressure/atmospheric pressure.

A section of the melt front here preferably means a coherent section of the melt front, for example a melt-front section moving onward in a particular subregion of the cavity. A region that follows this melt-front section with a chronological separation of at most 0.15 s means a region which, within the plastics melt, is arranged at a given juncture at a location which is within the cavity and at which the corresponding section of the melt front was present at most 0.15 s prior to this juncture. In other words, the spatial separation of this region from the corresponding melt front section corresponds to the distance that the melt front section has travelled within at most 0.15 s. If by way of example the relevant section of the melt front is moving at a constant velocity of 100 mm/s through the cavity, the distance between the relevant region and the melt front is permitted to be at most (100 mm/s)·(0.15 s)=15 mm. If the velocity of the melt front section is greater, the spatial separation of the corresponding region from the melt front section is therefore permitted to be greater than if the velocity of the melt front section is smaller.

The critical pressure of the blowing agent means the pressure above which the blowing agent is in supercritical solution with the plastics melt. At pressures above the critical pressure, the blowing agent exhibits no first-order phase transition between the gaseous and liquid phase, but instead then exhibits only a higher-order, generally second-order, phase transition. The critical pressure depends on the blowing agent used, and is by way of example 33.9 bar for nitrogen and 73.8 bar for carbon dioxide.

The temperature of the plastics melt and, respectively, of the blowing agent in this region is in particular also above the critical temperature of the blowing agent. The critical temperature is by way of example −146.95° C. for nitrogen and 31.0° C. for carbon dioxide, and is consequently in any case exceeded at the process temperatures typically encountered in structural foam molding.

For the purposes of the present invention, it has been discovered that the process described above can produce, by structural foam molding, a molding whose surface has a visually attractive appearance. The moldings that can be produced by this process have a visually structured surface which is reminiscent of an ice surface (appearance of ice).

Whereas the processes known hitherto from the prior art have in principle attempted to avoid the optical structuring of the molding surface, for example by concealing surface defects, the present invention is based on the discovery that the surface structuring can be used in a controlled manner to obtain a visually attractive molding surface. It has been discovered that the process described above, and specifically in particular the injection-velocity setting described, achieve an optical surface structuring of the moldings which replicates the structure of an ice surface. The moldings that can be produced by the process therefore have, in contrast to the visually homogeneous molding surfaces produced by the previous processes, an attractive visually structured molding surface.

In experiments with various materials, molding shapes, and molding thicknesses the described setting of the injection velocity has been found to be extremely widely applicable, and the process described above can therefore produce a wide variety of moldings with a corresponding appearance.

The process provides a plastics melt via melting of a thermoplastic. To this end there can by way of example be a separate melting oven provided, or a heated melting region of a screw conveyor used to transport the thermoplastic or the plastics melt, for example of an extruder. The thermoplastic can by way of example be introduced in the form of pellets into the melting oven or into the melting region, and can be heated there to a temperature above the melting point of the thermoplastic.

The process loads the plastics melt with a blowing agent. This means that a blowing agent is introduced into the plastics melt and brings about foaming of the plastics melt in the cavity of the mold. The blowing agent can be introduced physically, directly in the form of gas, into the plastics melt. A possible alternative is that a starting material for a blowing agent is introduced into the plastic or into the plastics melt (for example in the form of pellets or of powder), and by way of example forms the actual gaseous blowing agent when exposed to heat, preferably with progress of a chemical reaction.

The process injects the blowing-agent-loaded plastics melt under pressure into a cavity of a mold in such a way that the plastics melt fills the cavity behind a melt front proceeding through the cavity. At the beginning of this step, the cavity is initially empty or gas-filled. The plastics melt is then injected through an aperture into the cavity of the mold, and specifically with exterior application of pressure, in such a way that the plastics melt is forced into the cavity and becomes progressively distributed within the cavity. The melt front means the frontal boundary area of the plastics melt moving through the cavity.

Once the injection procedure has ended and the foamed thermoplastic has hardened, the molding can be removed from the mold. In the region of the at least one feed channel, the molding then has a sprue which is made of the plastics melt solidified in the feed channel and which can be removed prior to further use of the molding.

In the process, the injection velocity at which the plastics melt is injected into the cavity of the mold is adjusted in such a way that, in a region that follows a section of the melt front with a chronological separation of at most 0.15 s, at least at one juncture during the injection procedure, the internal pressure of the plastics melt in the cavity is greater than the critical pressure of the blowing agent.

In structural foam molding processes of the prior art, the pressure falls relatively rapidly within the plastics melt, from the injection aperture onward, and therefore the blowing agent is converted to the subcritical state well before the melt front has been reached. Evolution of gas from the plastics melt therefore begins at a relatively large distance from the melt front, thus producing in essence laminar flow of the plastics melt in the region of the melt front. This leads to a laminar and rather homogeneous or streaky appearance of the surface.

When the abovementioned criterion for the injection velocity is satisfied, the region in which the blowing agent is in supercritical state in the plastics melt (supercritical region) is brought close to the melt front. Experiments have revealed a chronological separation of less than 0.15 s achieves at least to some extent turbulent flow of the plastics melt in the region of the melt front, thus giving optical structuring of the surface to give the appearance of ice. The experiments have moreover revealed that as soon as the chronological separation of the supercritical region from the melt front is more than 0.15 s the appearance of ice is no longer achieved.

The internal pressure of the plastics melt in the relevant region must be greater, at least at one juncture during the injection procedure, than the critical pressure of the blowing agent. It has been found that a visually attractive surface with the appearance of ice is obtained even when the injection-velocity criterion described above has been satisfied at one juncture during the injection procedure. It is preferable that this juncture is at the beginning of the injection procedure, and specifically in particular is a juncture at which less than 20%, preferably less than 10%, in particular less than 5%, of the cavity have been filled by the plastics melt.

It has been found that the turbulence produced at the relevant juncture in the region of the melt front is sufficiently robust to continue after said juncture and to form an attractively optically structured surface in the plastics melt. However, a more uniform structured appearance of the surface can be achieved if the injection-velocity criterion described above has been satisfied over a longer period, in particular over more than 25% of the entire injection time, preferably over more than 50%, in particular over more than 75%. It is particularly preferable that the criterion described above is satisfied within the at least one feed channel. It is thus possible to achieve the appearance of ice on the molding immediately, starting at the gate mark.

The injection-velocity adjustment described above can be carried out in various ways. By way of example, pressure sensors can be provided within the cavity of the mold, in particular what are known as internal-mold-pressure sensors, and these can measure the internal pressure of the plastics melt in the cavity during injection, at various locations. By altering the injection velocity and determining the pressure profile with the aid of the sensors it is possible to establish a well-defined value for the injection velocity at which the desired internal-pressure profile is achieved in the plastics melt. Examples of suitable internal-mold-pressure sensors for this purpose are 6183BCE internal-mold-pressure sensors obtainable from Kistler Instrumente GmbH, Ostfildern, Germany.

Alternatively, the required injection velocity can also be determined by using rheological simulation of the injection procedure, in particular the use of a computer. By using this type of simulation it is possible to calculate, for a given mold and for a given composition of the thermoplastic melt, the internal pressure profile in the plastics melt for various injection velocities. On the basis of the profiles calculated it is then possible to select an injection velocity at which the desired internal pressure profile is achieved in the simulation. An example of suitable equipment for carrying out this type of simulation is “Autodesk (R) Simulation Moldflow (R)” rheological simulation software obtainable from Autodesk Inc., San Rafael, USA. A specific example of rheological simulation of the injection procedure is described at a later stage below in the context of the attached drawings.

The object described above is moreover at least to some extent achieved in the invention via a molding made of a foamed thermoplastic, in particular produced by structural foam molding, preferably by the process described above, where the molding has a surface region with optical structuring which is formed by the foamed thermoplastic and for which the averaged ratio of the gloss levels measured in the direction of flow to the gloss levels measured perpendicularly to the direction of flow is below 1.9, preferably below 1.5, in particular below 1.2.

The expression “the averaged ratio of the gloss levels measured in the direction of flow to the gloss levels perpendicularly to the direction of flow of a molding” means the parameter determined by the measurement method described on the basis of the following rules of measurement:
1. Measurement equipment that can be used is any of the optical measurement equipment that measures in accordance with DIN 67530.
2. The gloss levels are measured in accordance with DIN 67530 with an angle of incidence and an angle of reflection of 60°.
3. Measurements are made at six different measurement sites on the molding surface region to be studied.
4. The arrangement of the measurement sites is determined by starting from the origin, i.e. from the position of the gate during injection molding. If the molding studied has a plurality of gate marks, each gate mark can serve as starting point for determining the measurement ranges.
5. The measurement ranges are determined on the basis of maximal flow path length. Maximal flow path length is the distance between the gate mark of the molding and the point at the furthest distance therefrom (flow end point). If the molding studied has a plurality of gate marks, the weld line of the flow fronts from different gate marks can also be used as flow end point.
6. The measurement procedure described in points 7. to 9. below must be carried out for each gate mark.
7. The measurement ranges are as follows:
   two measurement points in the range from 10 to 25% of the maximal flow path length, two measurement points in the range from 40 to 60%, and two measurement points in the range from 75 to 90%.
8. The distance between the individual measurement points in each measurement range must be at least 25% of the prevailing flow path width.
9. For each measurement point the measurement equipment must respectively make three gloss level measurements in the direction of flow and perpendicularly to the direction of flow. The measurement area used for each of the gloss level measurements is at least 7×7 mm.
10. For each measurement i, the ratio of the gloss levels in the direction of flow G_{iFR,i} to the gloss levels perpendicularly to the direction of flow G_{qFR,i} is calculated: V_{G,i}=G_{iFR,i}/G_{qFR,i}.
11. The average value of all of the gloss level ratios previously determined is then calculated:

$${\overline{V}}_{G} = \frac{1}{n} {\sum }_{i = 1}^{n} {V}_{GJ} .$$

V̅_{G} is the averaged ratio of the gloss levels measured in the direction of flow to the gloss levels perpendicular to the direction of flow.

The parameter is preferably determined at planar surface regions. An example of measurement equipment that can be used for this gloss level measurement is the haze-gloss AG-4601 obtainable from BYK-Gardner GmbH, Geretsried, Germany. However, the parameter can also be determined at slightly curved surface regions. The gloss level measurements can then be made by using measurement equipment suitable for that purpose, an example being the ZGM 1020 gloss meter obtainable from Zehnter GmbH Testing Instruments, Sissach, Switzerland.

The expression “gloss level measurement in the direction of flow” in the measurement method described above means that the line of intersection of the plane of the incident and reflected beam with the molding surface during reflectivity measurement in the measurement region is in essence parallel to the direction of movement of the melt front in the region of measurement during the production of the molding. The expression “measurement perpendicularly to the direction of flow” correspondingly means that the line of intersection of the plane of the incident and reflected beam with the molding surface during reflectivity measurement in the measurement region is in essence perpendicular to the direction of movement of the melt front in the region of measurement during the production of the molding. The direction of movement of the melt front here in the molding depends on the position of the gate mark from which the plastics melt has flowed into the measurement region.

Moldings produced by processes known from the prior art exhibit a surface with a streaky appearance, because of the in essence laminar flow of the plastics melt in the region of the melt front. The streaks here run in essence from the gate in the direction of flow of the plastics melt, i.e. in the direction of movement of the melt front during the injection procedure. These streaks influence the directionally dependent gloss level of the molding surface in such a way that the gloss level in the direction of flow, i.e. in essence in the direction of the streaks, is higher than the gloss level perpendicularly to the direction of flow. The gloss level ratio in these moldings is therefore greater than 2.

In contrast to this, moldings which have a visually attractively structured surface with the appearance of ice, for example those in particular that can be produced by the process described above, have a gloss level ratio of at most 1.9, in particular of at most 1.5, or indeed at most 1.2. By virtue of the turbulent optical surface structures that bring about the appearance of ice, local reflectivity differences compensate for one another in a way that gives similar gloss levels in the direction of flow and perpendicularly to the direction of flow, thus giving a gloss level ratio closer to, or close to, 1. The visually attractive structured surface of the molding of the invention can therefore be characterized objectively by way of the gloss level ratio.

The surface region of the molding has optical structuring formed via the foamed thermoplastic. Optical structuring means that the optical properties of the surface region are not constant across the entire surface region but instead at least one optical property of the surface in the surface region, in particular the local gloss level of the surface, varies across the surface region. The optical structuring is formed via the foamed thermoplastic. It is thus clear that the optical structuring results from the actual foamed thermoplastic, and not by way of example via any additional, optically structured layer, for example a film, or a color layer. It is preferable that the foamed thermoplastic directly forms the surface region. However, it is also possible to arrange an in essence transparent layer above the thermoplastic, when the foamed thermoplastic continues to form the optical structuring of the surface.

Other embodiments of the process and, respectively, of the molding are described below. The features of said embodiments are not restricted here to the process and, respectively, the molding; features described there for the process can be applied correspondingly to the molding and vice versa.

In one embodiment of the process the region in which the internal pressure of the plastics melt is, at least at one juncture during the injection procedure, greater than the critical pressure of the blowing agent follows the section of the melt front with a chronological separation of at most 0.1 s, in particular of at most 0.05 s. It has been found that when the chronological separation of the region from the melt front is at most 0.15 s, visually attractive surface structuring is achieved in subregions of the molding. If the corresponding chronological separations selected are still smaller, preferably less than 0.1 s, and in particular less than 0.05 s, it is in essence possible to achieve correspondingly attractive surface structuring with the appearance of ice on the entire molding surface.

In another embodiment of the process and, respectively, of the molding, the thermoplastic is a transparent plastic, in particular a transparent plastic selected from the following group or comprising at least one plastic from this group: polycarbonates (PC), polystyrenes (PS), polymethyl methacrylates (PMMA), styrene-acrylonitriles (SAN), cycloolefin copolymers (COC), transparent polyamides (PA), for example PA MACMI 12, PA NDT/INDT, PA MACM 12, PA MACM 14, PA PACM 12, PA 6I, PA 6I/6T, transparent polyesters, for example A-PET (amorphous PET, PET with 5% of cyclohexanedimethanol or neopentyl glycol), PEN (polyethylene naphthalate), PTT (polytrimethylene terephthalate), PETG (terephthalic acid; ethylene glycol/cyclohexanedimethanol), polyesters made of terephthalic acid with cyclohexanedimethanol and tetramethylcyclobutanediol, and mixtures of these polymers. When a transparent plastic is used, the surface of the resultant molding remains at least to some extent transparent, and therefore even deeper-lying surface structures are externally visible. This increases the density of the structures visible at the surface, and thus achieves surface structuring with a realistic appearance of ice. The transparency of the thermoplastic preferably corresponds to light transmittance of at least 25%, preferably at least 50%, particularly preferably at least 75%, in particular at least 86%, measured in accordance with ISO 13468-2 for 1 mm thickness.

In another embodiment of the process and, respectively, of the molding the thermoplastic is selected from the following group or at least comprises a plastic from this group: polycarbonates (PC), polystyrenes (PS), polymethyl methacrylates (PMMA), styrene-acrylonitrile (SAN), polymers from the group of COCs (cyclodefin copolymers), transparent polyamides (PA), polyvinyl chlorides (PVC), polyphenylene ethers (PPE), and mixtures thereof.

Particularly good results for visually attractive surface structuring were achieved with the polycarbonate compositions described below:

For the purposes of the present invention, polycarbonates are not only homopolycarbonates and copolycarbonates, but also polyester carbonates as described by way of example in EP-A 1,657,281.

Aromatic polycarbonates are produced by way of example via reaction of diphenols with carbonyl halides, preferably phosgene, and/or with aromatic diacyl dihalides, preferably dihalides of benzenedicarboxylic acids, by the interfacial process optionally with use of chain terminators, for example monophenols, and optionally with use of trifunctional or more than trifunctional branching agents, for example triphenols or tetraphenols. Another possible production method uses a melt polymerization process via reaction of diphenols with, for example, diphenyl carbonate.

The polycarbonates to be used in the invention are in principle produced in a known manner from diphenols, carbonic acid derivatives, and optionally branching agents.

Processes for the synthesis of polycarbonates are in general terms known and described in numerous publications. EP-A 0 517 044, WO 2006/072344, EP-A 1 609 818, WO 2006/072344, and EP-A 1 609 818, and documents cited therein, describe by way of example the interfacial process and the melt process for the production of polycarbonate.

Diphenols for producing the aromatic polycarbonates and/or aromatic polyester carbonates are preferably those of the formula (I)

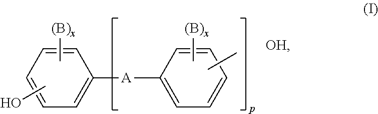

where
A is a single bond, C₁ to C₅-alkylene, C₂ to C₅-alkylidene, C₅ to C₆-cycloalkylidcne, —O—, —SO—, —CO—, —S—, —SO₂—, or C₆ to C₁₂-arylene, onto which further aromatic rings optionally comprising heteroatoms can have been condensed,
   or a moiety of the formula (II) or (III)

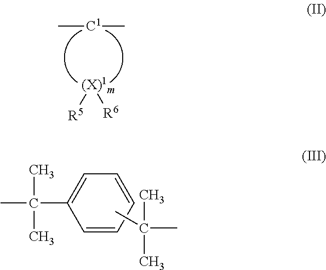

B is in each case C₁ to C₁₂-alkyl, preferably methyl or halogen, preferably chlorine and/or bromine,
x is mutually independently respectively 0, 1 or 2,
p is 1 or 0, and
R⁵ and R⁶ can be selected individually for each X¹, being mutually independently hydrogen or C₁ to C₆-alkyl, preferably hydrogen, methyl or ethyl,
X¹ is carbon and
m is an integer from 4 to 7, preferably 4 or 5, with the proviso that on at least one atom X¹, R⁵ and R⁶ are simultaneously alkyl.

Preferred diphenols are hydroquinone, resorcinol, dihydroxydiphenols, bis(hydroxyphenyl)-C₁-C₅-alkanes, bis(hydroxyphenyl)-C₅-C₆-cycloalkanes, bis(hydroxyphenyl) ethers, bis(hydroxyphenyl) sulfoxides, bis (hydroxyphenyl) ketones, bis(hydroxyphenyl) sulfones and α,α′-bis(hydroxyphenyl)diisopropylbenzenes, and also ring-brominated and/or ring-chlorinated derivatives of these.

Particularly preferred diphenols are 4,4′-dihydroxybiphenyl, bisphenol A, 2,4-bis(4-hydroxyphenyl)-2-methylbutane, 1,1-bis(4-hydroxyphenyl)cyclohexane, 1,1-bis(4-hydroxyphenyl)-3,3,5-trimethylcyclohexane, 4,4′-dihydroxydiphenyl sulfide, 4,4′-dihydroxydiphenyl sulfone, and also di- and tetrabrominated or chlorinated derivatives of these, for example 2,2-bis(3-chloro-4-hydroxyphenyl)propane, 2,2-bis(3,5-dichloro-4-hydroxyphenyl)propane or 2,2-bis(3,5-dibromo-4-hydroxyphenyl)propane. Particular preference is given to 2,2-bis(4-hydroxyphenyl)propane (bisphenol A).

The diphenols can be used individually or in the form of any desired mixtures. The diphenols are known from the literature or can be obtained by processes known from the literature.

Examples of a suitable chain terminator for producing the thermoplastic aromatic polycarbonates are phenol, p-chlorophenol, p-tert-butylphenol or 2,4,6-tribromophenol, or else long-chain alkylphenols, such as 4-[2-(2,4,4-trimethylpentyl)]phenol, 4-(1,3-tetramethylbutyl)phenol according to DE-A 2 842 005 or monoalkylphenols or dialkylphenols having a total of from 8 to 20 carbon atoms in the alkyl substituents, e.g. 3,5-di-tert-butylphenol, p-isooctylphenol, p-tert-octylphenol, p-dodecylphenol and 2-(3,5-dimethylheptyl)phenol and 4-(3,5-dimethylheptyl)phenol. The amount of chain terminators to be used is generally from 0.5 mol % to 10 mol %, based on the total molar amount of the respective diphenols used.

The average molar masses of the thermoplastic aromatic polycarbonates (mass average M_{w}, measured via GPC (gel permeation chromatography with polycarbonate standard)) are from 10 000 to 200 000 g/mol, preferably from 15 000 to 80 000 g/mol, particularly preferably from 20 000 to 38 000 g/mol.

The thermoplastic, aromatic polycarbonates can have any known type of branching, and specifically preferably via incorporation of from 0.05 to 2.0 mol %, based on the entirety of the diphenols used, of trifunctional or more than trifunctional compounds, such as those having three or more phenolic groups. It is preferable to use linear polycarbonates, and it is more preferable to use those based on bisphenol A.

Suitable materials are not only homopolycarbonates but also copolycarbonates. Another possibility for producing copolycarbonates of the invention according to component A, is to use from 1 to 25% by weight, preferably from 2.5 to 25% by weight, based on the total amount of diphenols to be used, of polydiorganosiloxanes having hydroxyaryloxy end groups. These are known (U.S. Pat. No. 3,419,634) and can be produced by processes known from the literature. Polydiorganosiloxane-containing copolycarbonates are likewise suitable; the production of polydiorganosiloxane-containing copolycarbonates is described for example in DE-A 3 334 782.

Preferred polycarbonates, alongside the bisphenol A homopolycarbonates, are the copolycarbonates of bisphenol A with up to 15 mol %, based on the total molar amounts of diphenols, of diphenols other than those mentioned as preferred or as particularly preferred, in particular 2,2-bis(3,5-dibromo-4-hydroxyphenyl)propane.

Preferred aromatic diacyl dihalides for producing aromatic polyester carbonates are the diacyl dichlorides of isophthalic acid, terephthalic acid, and diphenyl ether 4,4′-dicarboxylic acid and of naphthalene-2,6-dicarboxylic acid.

Particular preference is given to mixtures of the diacyl dichlorides of isophthalic acid and of terephthalic acid in a ratio of from 1:20 to 20:1.

Production of polyester carbonates also makes concomitant use of a carbonyl halide, preferably phosgene, as bifunctional acid derivative.

Chain terminators that can be used for producing the aromatic polyester carbonates are not only the abovementioned monophenols but also the chlorocarbonic esters of these, and also the acyl chlorides of aromatic monocarboxylic acids, which can optionally have substitution by C₁ to C₂₂-alkyl groups or by halogen atoms; aliphatic C₂ to C₂₂-monoacyl chlorides can also be used as chain terminators here.

The amount of chain terminators is in each case from 0.1 to 10 mol %, based on moles of diphenol in the case of the phenolic chain terminators and on moles of diacyl dichloride in the case of monoacyl chloride chain terminator.

Production of aromatic polyester carbonates can also use one or more aromatic hydroxycarboxylic acids.

The aromatic polyester carbonates can either be linear or can have any known type of branching (in which connection see DE-A 2 940 024 and DE-A 3 007 934), preference being given here to linear polyester carbonates.

Examples of branching agents that can be used are acyl chlorides of functionality three or higher, e.g. trimesoyl trichloride, cyanuroyl trichloride, 3,3′,4,4′-benzophenonetetracarbonyl tetrachloride, 1,4,5,8-naphthalenetetracarbonyl tetrachloride or pyromellitoyl tetrachloride, in amounts of from 0.01 to 1.0 mol % (based on diacyl dichlorides used) or tri- or polyfunctional phenols, such as phloroglucinol, 4,6-dimethyl-2,4,6-tri(4-hydroxyphenyl)hept-2-ene, 4,6-dimethyl-2,4,6-tri(4-hydroxyphenyl)heptane, 1,3,5-tri(4-hydroxyphenyl)benzene, 1,1,1-tri(4-hydroxyphenyl)ethane, tri(4-hydroxyphenyl)phenylmethane, 2,2-bis[4,4-bis(4-hydroxyphenyl)cyclohexyl]propane, 2,4-bis(4-hydroxyphenylisopropyl)phenol, tetra(4-hydroxyphenyl)methane, 2,6-bis(2-hydroxy-5-methylbenzyl)-4-methylphenol, 2-(4-hydroxyphenyl)-2-(2,4-dihydroxyphenyl)propane, tetra(4-[4-hydroxyphenylisopropyl]phenoxy)methane, 1,4-bis[4,4′-dihydroxytriphenyl)methyl]benzene, in amounts of from 0.01 to 1.0 mol %, based on diphenols used. Phenolic branching agents can be used as initial charge with the diphenols, and acyl chloride branching agents can be introduced together with the acyl dichlorides.

The proportion of carbonate structural units in the thermoplastic, aromatic polyester carbonates can vary as desired. The proportion of carbonate groups is preferably up to 100 mol %, in particular up to 80 mol %, particularly preferably up to 50 mol %, based on the entirety of ester groups and carbonate groups. The ester fraction of the aromatic polyester carbonates, and also the carbonate fraction thereof, can take the form of blocks or can have random distribution in the polycondensate.

The thermoplastic aromatic polycarbonates and polyester carbonates can be used alone or in any desired mixture.

In another embodiment of the process, the plastics melt is loaded physically with a blowing agent via introduction of a gas, in particular of nitrogen or carbon dioxide, into the plastics melt.

Physical loading with a blowing agent is preferred in the process because this method can avoid degradation of the plastic, in particular of the polycarbonate, caused by chemical blowing agent, and can also avoid discoloration, in particular yellowish discoloration, of the plastics melt caused by residues from the blowing agent and/or caused by degradation of the plastic.

It is alternatively also possible to load the plastics melt chemically with a blowing agent, in that a blowing agent starting material is added to the thermoplastic and then forms the gaseous blowing agent in the plastics melt, for example by means of a chemical reaction induced via exposure to heat. The starting material for the blowing agent can be added to the plastics pellets before melting, or else can be added to the actual plastics melt, for example as powder or pellets, or else in liquid form. Examples of these chemical blowing agents are 5-phenyltetrazole (obtainable for example as Tracel IM 2240 Standard from TRAMACO GmbH, Pinneberg, Germany), or a preparation made of polycarboxylic acid and carbon components (obtainable by way of example as Hydrocerol ITP 833 from Clariant International Ltd., Muttenz, Switzerland).

The concentration of blowing agent is preferably at least 0.01% by weight.

In another embodiment of the process, the concentration of the blowing agent in the blowing-agent-loaded plastics melt before injection into the cavity is from 0.5 to 3% by weight for chemical blowing agents and from 0.2 to 1% by weight for physical blowing agents.

In another embodiment of the process, the design of the mold is such that, in the direction of flow of the plastics melt, the cross section of the cavity does not narrow by more than 10%, and preferably does not narrow at all. Narrowing of the cross section means reduction of the cross section of the cavity in the direction of flow of the plastics melt. This type of narrowing of the cross section can lead to laminarization of the thermoplastic in the region of the melt front in such a way that behind the narrowing of the cross section there is no further formation of structured surface with the appearance of ice. The plastics melt naturally flows only until it reaches the edge of the cavity, and the final narrowing of the cross section at the edge of the cavity is therefore ignored here.

The design of the mold is preferably such that during the transition from the feed channel to the molding region of the cavity (i.e. at the gate mark of the component to be produced) the cross section of the cavity enlarges greatly, by at least 25%, preferably by at least 50%. This type of enlargement of cross section promotes a rapid pressure decrease in the region of the melt front, and thus promotes compliance with the criterion described above for the internal pressure profile of the plastics melt at the transition. A rapid pressure decrease can be further promoted by particularly preferably increasing the cross section by at least 150%, in particular by at least 250%, at the transition from the feed channel to the molding region.

In another embodiment of the process, the mold has been designed for a film gate or for a direct gate. A film gate means a gate of which the cross section increases in the direction of the actual molding. This type of gate arises when the cross section of the feed channel increases greatly in one direction, at least in a final section leading to the molding region of the cavity, thus giving a broad flow front of the thermoplastic melt. A direct gate arises when the cross section of the feed channel is in essence constant or increases only slightly. If the mold has a plurality of feed channels, all of the feed channels may have been designed for a film gate, or all of the feed channels may have been designed for a direct gate. A combination of feed channels designed for a film gate and for a direct gate is moreover also possible. In the case of a film gate, a large increase of cross section takes place in the region before the end of the feed channel, and therefore compliance with the abovementioned criterion for the internal pressure profile of the plastics melt is promoted before the end of the feed channel. In the case of a direct gate, a large increase of cross section takes place at the transition from the feed channel to the molding region, thus promoting compliance with the abovementioned criterion for the internal pressure profile of the plastics melt in the region of the gate mark.

In another embodiment of the molding, the surface region with the optical surface structuring which is formed via the foamed thermoplastic comprises a proportion of at least 30% of the entire surface of the molding. With the present invention, and in particular with the process described above, it is possible to achieve specific setting of the parameters for the production of this type of visually structured surface with the appearance of ice in a manner that in essence permits design of any desired, in particular including large, parts of the molding surface with an attractive structured surface with the appearance of ice. The corresponding surface region is preferably at least 50%, or more preferably at least 70%, of the entire surface of the molding.

In another embodiment of the molding, the thickness of the molding is in the range from 1 to 20 mm, preferably from 2 to 12 mm, in particular from 2 to 8 mm. By virtue of a minimal thickness of 1 mm, preferably of 2 mm, it is possible to achieve stable turbulent flow within the plastics melt in a way that permits development of an attractively structured surface over a large area. When molding thicknesses are smaller it has proven difficult to achieve turbulent flow of the plastics melt over relatively large areas.

The object described above is moreover at least to some extent achieved in the invention via the use of a molding described above as component for items of furniture or lighting elements, product casings, in particular cellphone covers, or as cups, bowls, and protective covers, coolboxes or cladding parts for coolboxes, or as multiple-use containers for refrigerated and fresh products, in particular for the logistics sector.

Other features and advantages of the process, of the molding, and of its use are apparent from the description below of a plurality of embodiments, with reference to the attached drawing.

The drawing shows,

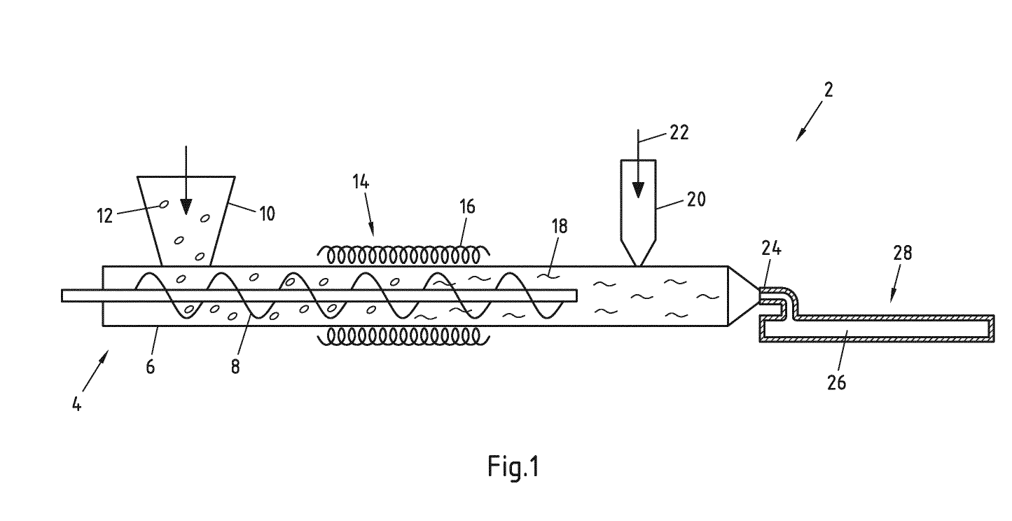

in FIG. 1, a diagram of an apparatus for carrying out a process in one embodiment of the process of the invention,

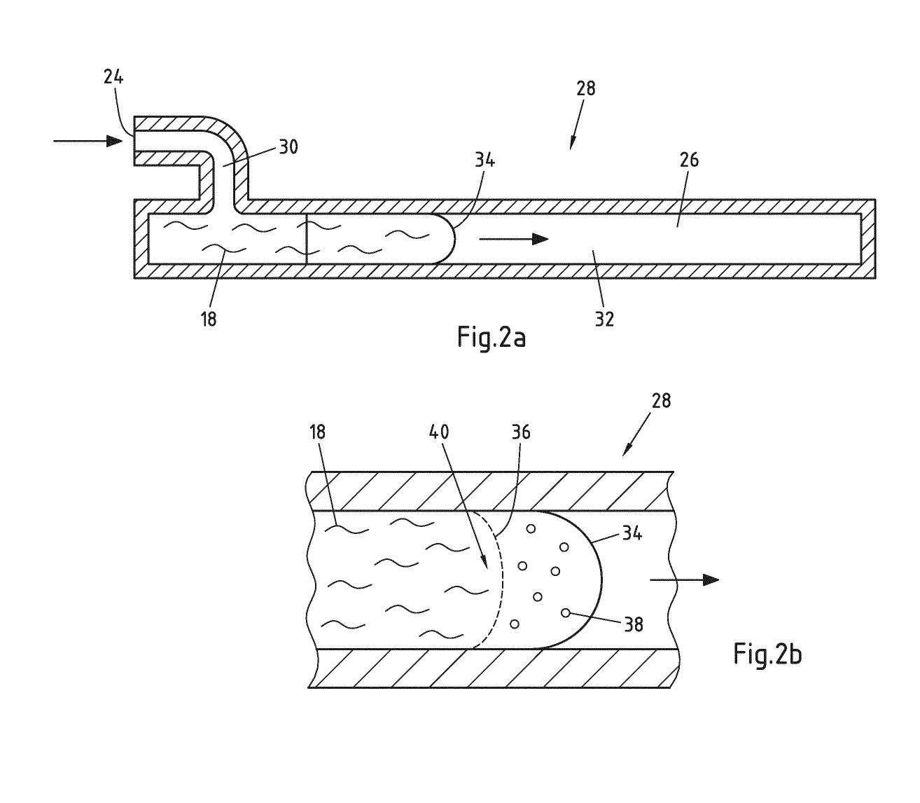

in FIG. 2a, a mold of the apparatus from FIG. 1, depicted during the injection of a plastics melt during conduct of an embodiment of the process of the invention,

in FIG. 2b, an enlarged detail from FIG. 2a,

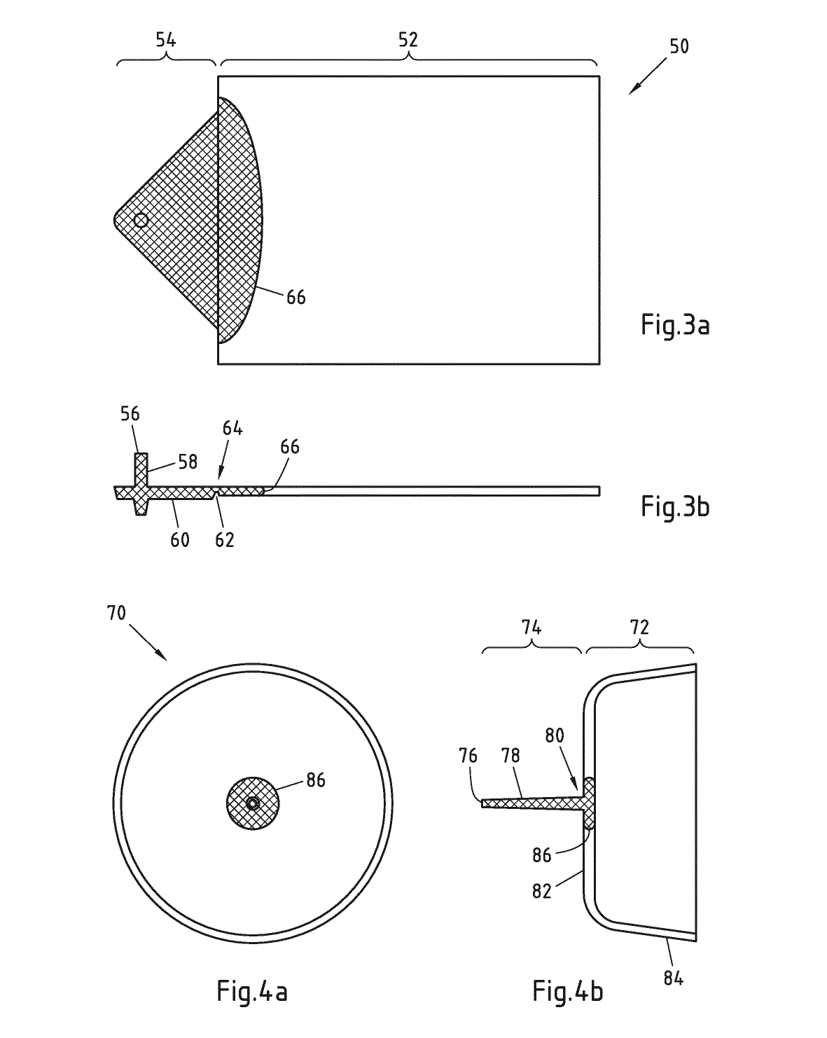

in FIG. 3a-b, a depiction of a mold cavity for a sheet molding in plan view and in cross section,

in FIG. 4a-b, a depiction of a mold cavity for a bowl-shaped molding, in plan view and in cross section,

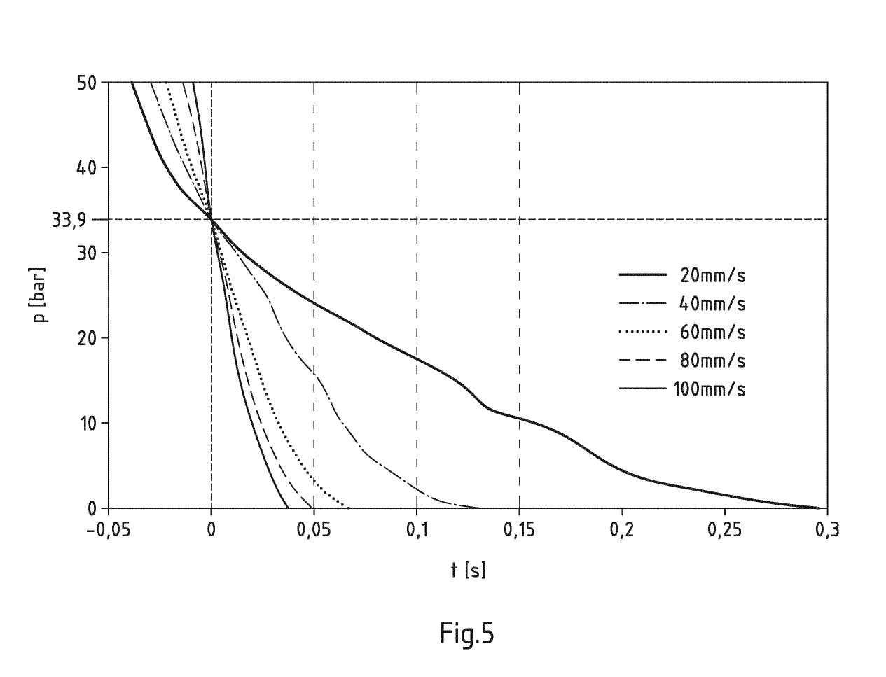

in FIG. 5, a graph showing simulated internal pressure profiles in the mold from FIG. 3a-b for various injection velocities,

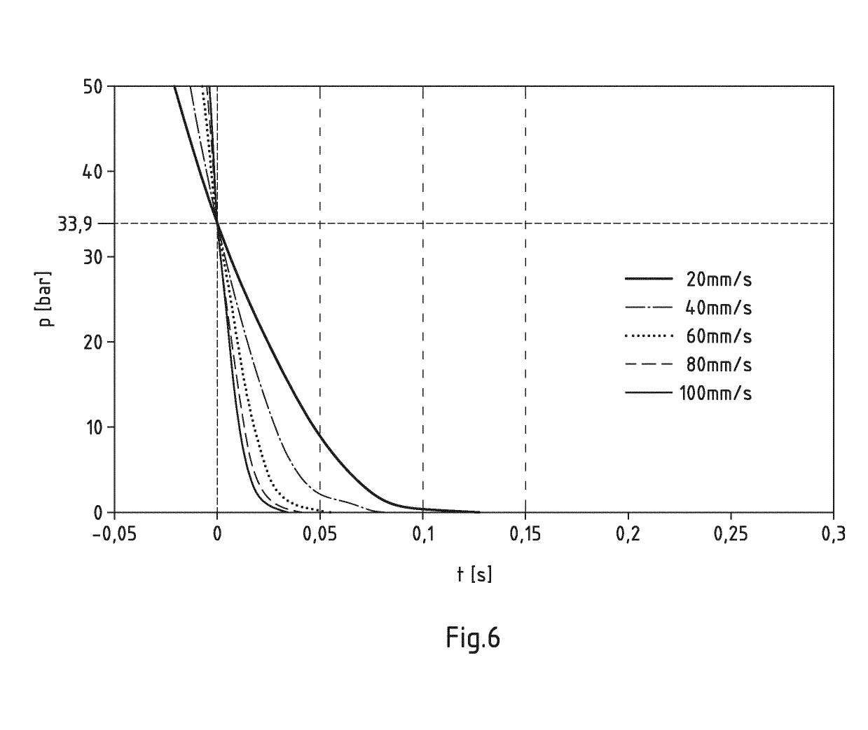

in FIG. 6, a graph showing simulated internal pressure profiles in the mold from FIG. 4a-b for various injection velocities, and

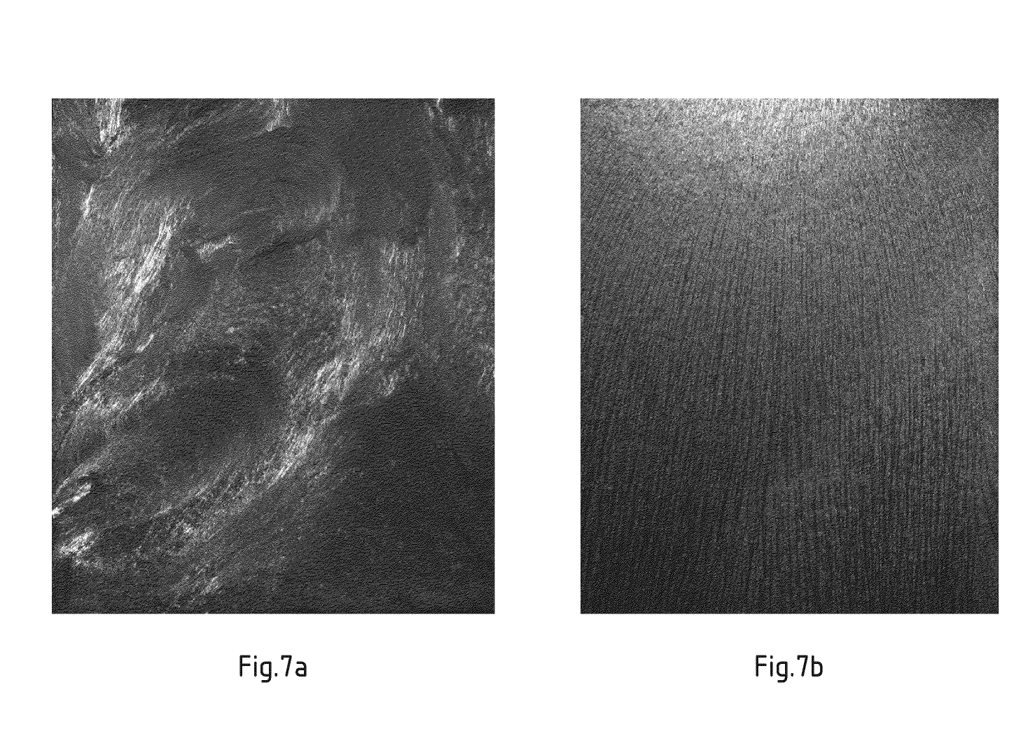

in FIG. 7a-b, an image of a molding surface of a molding of the invention, and also of a comparative molding.

FIG. 1 shows a structural foam molding apparatus of the type that by way of example can be used to carry out a process in an embodiment of the process of the invention.

The apparatus 2 comprises a screw conveyor 4 with a conveyor tube 6 designed as hollow cylinder, and with a driven transport screw 8 mounted rotatably in the conveyor tube 6. The apparatus 2 moreover has a feed neck 10 for input of plastics pellets 12. The pellets 12 are transported by the transport screw 8 from the feed region into a melt region 14 which has heating elements 16, in order to heat the plastic in the conveyor tube 6 to a temperature above its melting point and thus produce a plastics melt 18. The plastics melt 18 is further transported in the conveyor tube 6 in a region which is in front of the transport screw 8 and in which there is a blowing agent inlet 20 arranged, through which a blowing agent 22 (by way of example carbon dioxide or nitrogen) can be introduced into the plastics melt 18 in the conveyor tube 6. For the conduct of the injection procedure, the transport screw 8 is translated in the direction of the injection aperture in such a way that the plastics melt 18 loaded with the blowing agent 22 is injected through an injection aperture 24 into the cavity 26 of a mold 28. The plastics melt 18 then spreads behind a melt front proceeding through the cavity 26, and thus fills the cavity 26. During this injection procedure, the plastics melt 18 loaded with the blowing agent foams by virtue of the blowing agent.

FIGS. 2a and 2b show the mold 28 of the apparatus 2 from FIG. 1 in cross section from the side during the injection of a plastics melt during conduct of an embodiment of the process of the invention. FIG. 2b here shows an enlarged detail from FIG. 2a.

The cavity 26 of the mold 28 comprises a feed channel 30, in the present case designed for a film gate, and also a molding region 32 which corresponds to the exterior shape of the required molding.

During the conduct of the process, the blowing-agent-loaded plastics melt 18 is injected through the injection aperture 24 into the cavity 26. The plastics melt then fills the cavity 26 behind a melt front 34 proceeding through the cavity 26, and specifically this occurs initially in the region of the feed channel 30 and then in the molding region 32 of the cavity. The injection of the plastics melt 18 into the cavity 26 takes place under pressure, whereupon a pressure gradient becomes established from the location of the injection aperture 24 extending to the melt front 34. In that region of the plastics melt 18 where the internal pressure is above the critical pressure of the blowing agent, the blowing agent is in supercritical solution with the plastics melt 18. Since the internal pressure decreases from the injection aperture 24 to the melt front 34, the internal pressure of the plastics melt 18 becomes less than the critical pressure of the blowing agent at a point 36, and blowing agent between this point 36 and the melt front 34 is therefore no longer in supercritical solution with the plastics melt 18, and therefore evolves gas bubbles 38.

The injection velocity, i.e. the velocity at which the transport screw 8 is moved in the direction of the injection aperture 24 in order to inject the plastics melt 18 into the injection aperture 24, is adjusted in such a way that the chronological separation between the melt front 34 and a region 40 in which the plastics melt retains an internal pressure that is greater than the critical pressure of the blowing agent, and in which therefore the blowing agent is in supercritical state, is at most 0.15 s. This chronological separation corresponds to a spatial distance that is traveled within 0.15 s by the melt front 34.

Experiments have revealed that this type of small separation between the region 40 with supercritical blowing agent and the melt front 34 leads to turbulent flow in the region of the melt front 34, in such a way that the resultant molding has an esthetic visually structured surface with the appearance of ice.

FIGS. 3a-b show a diagram of a mold cavity 50 for a sheet molding in plan view (FIG. 3a) and in cross section (FIG. 3b). The cavity 50 comprises a molding region 52 and a feed channel 54. The feed channel 54 extends from an injection aperture 56 through which, during the injection procedure, the plastics melt is injected into the mold, initially in a tubular section 58 and then in a continuously widening, flat section 60 extending as far as the molding region 52. The width of the cross section of the feed channel 54 increases considerably in the flat section 60 extending as far as the molding region 52, in such a way that when the plastics melt is injected a uniform, broad melt front is formed. A gate produced with this type of feed channel is also termed film gate. After a small cross-sectional narrowing 62, which serves inter alia to permit easier removal of the solidified sprue region of the plastics melt from the actual molding, the cross section increases abruptly at the transition from the feed channel 54 to the molding region 52. This is in particular assisted via a relatively small width of the feed channel 54 in comparison with the molding region 52 at the transition, and also via the brief cross-sectional narrowing 62. The prior art generally uses the term gate mark 64 for the transition of the feed channel 54 to the molding region 52 in the molding produced by the cavity 50 (even when the transition in the present case corresponds to a rectangular area with large side-to-side ratio).

Table 1 states the dimensions of the cavity 50 depicted as example in FIG. 3a-b:

TABLE 1
Geometry of cavity for the sheet molding

| Variable | Dimension |
|---|---|
| Height of molding region (wall thickness) | 3.5 mm |
| Width of molding region (perpendicularly to the direction | 150.0 mm |
| of flow of the plastics melt in the gate) | |
| Length of molding region (in the direction of flow of the | 200.0 mm |
| plastics melt in the gate) | |
| Width of feed channel at the transition to the molding region | 120.0 mm |
| Cross-sectional enlargement at the transition to the | 75% |
| molding region | |

During the injection procedure, the plastics melt injected into the injection aperture 56 fills the cavity 50 behind a melt front 66 progressing through the cavity 50. The melt front 66 here proceeds initially through the tubular section 58 and then through the flat section 60 of the feed channel 54, before it then proceeds through the molding region 52. FIGS. 3a-b indicate the position of the melt front 66 by way of example for a juncture at which the melt front 66 has already entered the molding region 52.

FIGS. 4a-b are diagrams of a mold cavity 70 for a bowl-shaped molding in plan view (FIG. 4a) and in cross section (FIG. 4b). The cavity 70 comprises a molding region 72 and a feed channel 74. The feed channel 74 extends from an injection aperture 76, through which the plastics melt is injected into the mold during the injection procedure, in a tubular section 78 that widens slightly in the manner of a cone as far as the molding region 72. A gate resulting from this type of feed channel 74 is also termed direct gate. The transition of the feed channel 74 to the molding region 72 takes place in essence perpendicularly to a wall section of the molding region 72, i.e. perpendicularly with respect to a region that forms a wall of the injected molding. After a slight increase of cross section in the conical section 78, therefore, the cross section increases abruptly during the transition from the feed channel 74 to the molding region 72. The transition of the feed channel 74 to the molding region 72 is termed gate mark 80 for the molding produced by the cavity 70. The molding region 72 comprises a base region 82 and an edge region 84, and these respectively form the base and the edge of the bowl that can be produced by the cavity 70.

Table 2 states the dimensions of the cavity 70 depicted as example in FIG. 4a-b:

TABLE 2
Geometry of cavity for the bowl-shaped molding

| Variable | Dimension |
|---|---|
| Diameter of base region | 112 mm |
| Largest diameter of edge region | 170 mm |
| Height of edge region (from base region to upper bowl edge) | 70 mm |
| Wall thickness of base region (at gate mark) | 4.8 mm |
| Smallest wall thickness of edge region | 3 mm |
| Diameter of feed channel at gate mark | 9 mm |
| Cross-sectional enlargement during transition to molding | 113% |
| region | |

During the injection procedure, the plastics melt injected into the injection aperture 76 fills the cavity 70 behind a melt front 86 progressing through the cavity 70. The melt front 86 here initially proceeds through the feed channel 74, and then proceeds through the molding region 72. FIGS. 4a-b indicate the position of the melt front 86 by way of example for a juncture at which the melt front 86 has already entered the molding region 72.

For each of the mold cavities 50 and 70 depicted in FIGS. 3a-b and 4a-b, rheological simulations were carried out for injection procedures at various injection velocities, in order to determine the internal pressure profile of the plastics melt during the injection procedure.

The rheological simulations here were in each case carried out as follows:

The “Autodesk® Simulation Moldflow® Insight 2013 FCS—lantanum_fcs” program was used for the injection simulation calculations. The mold cavities 50 and 70 depicted in FIGS. 3a-b and 4a-b, with the stated dimensions, were first replicated in the computer program.

The following parameters were then moreover defined for the simulation of the injection procedures:

The plastic selected for use for the simulation was the polycarbonate Makrolon AL2647, obtainable from Bayer MaterialScience AG, Leverkusen, Germany. The material parameters used for the simulation of this plastic were those from the material database file for Makrolon AL2647 provided by Bayer MaterialScience AG, Leverkusen, Germany, for the users in particular of said computer program.

In particular, the simulation of the viscosity η (in Pa·s) of the plastics melt used the Cross-WLF viscosity model with the formula

$$\begin{matrix}η = \frac{{η}_{0}}{1 + {( \frac{{η}_{0} \dot{γ}}{{τ}^{*}} )}^{1 - n}} , & ( 1 ) \\ where & \\ {η}_{0} = {D}_{1} exp ( - \frac{{A}_{1} ( T - {T}^{*} )}{{A}_{2} ( T - {T}^{*} )} ) . & ( 2 )\end{matrix}$$

and T is the temperature (in K), T=D₂+D₃p is the glass transition temperature (in K), A₂=A₃+D₃p, p is the pressure (in Pa) and \dot{γ} is the shear rate (in s⁻¹), and where the individual parameters were selected in accordance with table 3:

TABLE 3
Parameters for the cross-WLF viscosity model

| Parameter | Value | |
|---|---|---|
| n | 0.1555 | |
| τ* | 740 472 | Pa |
| D₁ | 5.45517e+11 | Pa · s |
| D₂ | 417.15 | K |
| D₃ | 0 | K/Pa |
| A₁ | 28.056 | |
| A₂ | 51.6 | K |

For the thermodynamic behavior of the plastics melt, i.e. for the dependency of the specific volume v of the plastics melt of the temperature T (in K) and on the pressure p (in Pa) a 2-domain Tait pvT model was used with the formula

$$v ( T , p ) = {v}_{0} ( T ) ( 1 - C ln ( 1 + \frac{p}{B ( T )} ) ) + {v}_{i} ( T , p ) , \qquad ( 3 )$$

where v₀=b₁ₘ+b₂ₘ(T−b₅)B(T)=b₃ₘ exp(−b₄ₘ (T−b₅))vₜ(T, p)=0 for T>Tₜ, and v₀=b₁ₛ+b₂ₛ(T−b₅)B(T)=b₃ₛ exp(−b₄ₛ(T−b₅))vₜ(T, p)=b₇ exp(b₈(T−b₅)−b₉p) for T≦Tₜ, where Tₜ(p)=b₅+b₆p, where C=0.0894, and where the individual parameters were selected in accordance with table 4:

TABLE 4
Parameters for the 2-domain Tait pvT model

| Parameter | Value | |
|---|---|---|
| b₅ | 427.97 | K |
| b₆ | 2.487e−7 | K/Pa |
| b₁ₘ | 0.008738 | m³/kg |
| b₂ₘ | 6.497e−7 | m³/(kg K) |
| b₃ₘ | 8.86889e+7 | Pa |
| b₄ₘ | 0.003935 | K⁻¹ |
| b₁ₛ | 0.0008738 | m³/kg |
| b₂ₛ | 2.927e−7 | m³/(kg K) |
| b₃ₛ | 1.00166e+8 | Pa |
| b₄ₛ | 0.001681 | K⁻¹ |
| b₇ | 0 | m³/kg |
| b₈ | 0 | K⁻¹ |
| b₉ | 0 | Pa⁻¹ |

The Makrolon AL2647 density values provided for the simulations were moreover 1.0329 g/cm³ for the melt, and 1.1965 g/cm³ for the solid-state density.

The blowing agent (in this case nitrogen) was ignored for the sake of simplicity in the simulations, because experiments have shown that even when the blowing agent is ignored the simulations provide useful and comparable internal pressure distribution results.

Table 5 below states the other parameters used for the simulations:

TABLE 5
Other simulation parameters

| Process parameter | Value | |
|---|---|---|
| Mold surface temperature | 100° | C. |
| Minimal mold surface temperature | 80° | C. |
| Maximal mold surface temperature | 120° | C. |
| Melting point plastic | 300° | C. |
| Minimal melting range temperature | 280° | C. |
| Maximal melting range temperature | 320° | C. |
| Absolute maximum of melting point | 360° | C. |
| Injection temperature | 130° | C. |
| Maximal transverse stress | 0.5 | MPa |
| Maximal shear rate | 40 000 | s⁻¹ |

The simulations simulated an injection procedure using a screw conveyor with screw diameter 50 mm. The quantity of the plastics melt injected via translation of the screw into the respective cavity was adjusted in each case to be appropriate to the corresponding volume of the cavity 50 and, respectively, 70.

For each of the two cavities 50 and 70, the injection procedure was simulated respectively with an injection velocity of 20, 40, 60, 80, and 100 mm/s. The injection velocity here corresponds in each case to the velocity at which the screw is translated during the injection procedure. The volume per second injected into the cavity is thus calculated from the product of the injection velocity and the cross section of the screw conveyor (=πD²/4 where D=50 mm).

In each case, the injection procedure was simulated from its start (i.e. when the location of the melt front is at the injection aperture 56 and, respectively, 76) as far as the position depicted in FIGS. 3a-b and, respectively, 4a-b for the melt front 66 and 86 (i.e. when the respective melt front 66 and, respectively, 86 has entered the molding region 52 and, respectively, 72).

The simulations were in each case used to determine internal pressure profiles of the plastics melt at the juncture depicted in FIGS. 3a-b and 4a-b, i.e. after entry of the respective melt front into the molding region. The internal pressure profiles for the various injection velocities are depicted in the graph in FIG. 5 for the cavity from FIG. 3a-b and in the graph in FIG. 6 for the cavity from FIG. 4a-b.

The graphs in FIGS. 5 and 6 show the local internal pressure in the plastics melt as a function of the position within the cavity. The position in the cavity is shown on the abscissa here as time in seconds. The juncture at 0 s corresponds in each case to that position in the cavity at which the internal pressure of the plastics melt falls below 33.9 bar, which is the critical pressure of the nitrogen blowing agent used for the plastics melt in the present case, this pressure being depicted by the horizontal line in FIGS. 5 and 6. A particular time t>0 then in each case corresponds to the position of a small volume of the plastics melt in the cavity, where the location of said volume before a period of duration t was still at the position t=0 s. If by way of example the flow velocity of said volume is constant at v, the spatial separation a from the position t=0 along the direction of flow is calculated from the product s=v·t.

The (chronological) position of the melt front in FIGS. 5 and 6 corresponds to that point at which the respective curve falls in essence to a pressure of 0 bar (or to ambient pressure/atmospheric pressure), i.e. intersects with the abscissa. In the region of the melt front the plastics melt is in essence not subject to any significant counterpressure from the as yet unfilled region of the cavity, and the pressure at the melt front therefore in essence falls abruptly to 0 bar (or to ambient pressure/atmospheric pressure).

Since the time axis in FIGS. 5 and 6 has been standardized in such a way that t=0 s corresponds to the position where the pressure falls below the critical pressure, the chronological separation between the melt front (or a section thereof) and a region in which the internal pressure of the plastics melt is greater than the critical pressure of the blowing agent can be read directly from FIGS. 5 and 6; this chronological separation namely corresponds precisely to the chronological position of the melt front.

In the present invention this chronological separation is permitted to be at most 0.15 s, preferably at most 0.1 s, and more preferably at most 0.05 s. These limits are emphasized by vertical lines in FIGS. 5 and 6. The region between 0.15 s and 0.1 s here can be termed transition region, since with these chronological separations the desired surface structuring with the appearance of ice is very generally obtained, but sometimes not quite uniformly across the entire molding. For chronological separations below 0.1 s, and certainly below 0.05 s, the desired surface structuring with the appearance of ice could be achieved over an entire surface.

It is then possible to read from FIGS. 5 and 6 the injection velocities for which the abovementioned condition is met.

For the sheet component, FIG. 5 shows that an injection velocity of 20 mm/s is too small, since the chronological separation between the critical internal pressure region and the melt front here is almost 30 s. The value at 40 mm/s is in the transition region, and injection velocities of 60, 80, or 100 mm/s comply with the required criterion in such a way that the desired surface structuring with the appearance of ice can be achieved reliably and in essence over an entire surface with these injection velocity values.

For the bowl-shaped component, FIG. 6 shows that an injection velocity of 20 mm/s reaches the transition region, while injection velocities of at least 40 mm/s comply with the required criterion in such a way that the desired surface structuring with the appearance of ice can be achieved reliably and in essence over an entire surface with these injection velocity values.

The injection procedures described above were not only simulated but also carried out in practice.

For this, two molds were used, corresponding to FIGS. 3a-b and 4a-b, attached to an ARBURG Allrounder 570C screw conveyor obtainable from ARBURG GmbH & CoKG, Lossburg, Germany, with screw diameter 50 mm.

Makrolon AL2647 polycarbonate pellets, obtainable from Bayer MaterialScience AG, Leverkusen, Germany, were charged to the screw conveyor, where they were heated to a temperature of 300° C. to form a plastics melt. The screw of the screw conveyor was then in each case used to transport, in the hollow cylinder surrounding the screw, a volume adapted to be appropriate to the volume of the respective mold cavity to a position in front of the mold-facing end of the screw.

During the injection procedure, the screw was then in each case translated forward, i.e. in the direction of the mold, with the appropriate injection velocity, in such a way as to inject the plastics melt from the screw conveyor through the injection aperture 56 and, respectively, 76 into the cavity of the corresponding mold 50 and, respectively, 70. Shortly before injection into the respective injection aperture, the plastics melt was moreover loaded with 0.60% by weight of nitrogen, in order to foam the plastics melt in the cavity.

Findings on the sheet moldings produced in the manner described above were that the desired surface structuring with the appearance of ice was not achieved at injection velocities of 20 mm/s, was achieved over part of a surface at injection velocities of 40 mm/s, and was achieved over an entire surface at injection velocities of 60 mm/s and above.

Findings on the bowl-shaped moldings produced in the manner described above were that the desired surface structuring with the appearance of ice was achieved over part of a surface at injection velocities of 20 mm/s, and was achieved over an entire surface at injection velocities of 40 mm/s and above.

The overall findings in the experiments were that the desired surface structuring with the appearance of ice was achieved for those injection velocities at which compliance with the abovementioned criterion for the internal pressure profile of the plastics melt was achieved.

FIG. 7a shows the surface of the sheet molding (of the invention) produced with an injection velocity of 60 mm/s. FIG. 7b shows, for comparison, the surface of the sheet molding (not of the invention) produced with an injection velocity of 20 mm/s.

Whereas the surface of the molding not produced in the invention in FIG. 7b reveals a regular, streaky, laminar surface structure, the result for the molding produced in the invention in FIG. 7a is the desired turbulent surface structuring reminiscent of the appearance of ice.

Objective differentiation between inventive surface structures (e.g. FIG. 7a) and non-inventive surface structures (e.g. FIG. 7b) can be achieved by determining the averaged ratios of the gloss levels measured in the direction of flow to the gloss levels perpendicularly to the direction of flow on the basis of the measurement method described above.

Haze-gloss AG-4601 gloss level measurement equipment, obtainable from BYK-Gardner GmbH, Geretsried, Germany was used to determine the gloss level ratios in accordance with the test method described above on a series of moldings produced in the invention and on a series of comparative components, and in particular on the moldings from FIGS. 5 and 6.

Table 6 shows the results of the gloss level measurements parallel to and perpendicularly to the direction of flow at in each case six measurement points for three moldings (A-C) produced in the invention and three comparative moldings (D-F) not produced in the invention. The moldings produced in the invention here have turbulent surface structuring comparable with the surface structuring depicted in FIG. 7a, whereas the moldings not produced in the invention have in each case streaky, laminar surface structuring comparable with the surface structuring depicted in FIG. 7b.

The units of the gloss level measurements in table 7 correspond to the gloss level units used by the abovementioned equipment. They are not stated in the present case because in the final analysis the only important factor is the ratio of the gloss levels.

TABLE 6
Results of the gloss level measurements

| Measurement | | | | | | | |
|---|---|---|---|---|---|---|---|
| point | Direction | A | B | C | D | E | F |
| 1 | perpendicular | 11 | 7 | 8 | 13 | 13 | 13 |
| 2 | perpendicular | 13 | 8 | 5 | 15 | 13 | 13 |
| 3 | perpendicular | 7 | 8 | 6 | 13 | 14 | 15 |
| 4 | perpendicular | 7 | 8 | 7 | 14 | 14 | 15 |
| 5 | perpendicular | 11 | 11 | 12 | 19 | 12 | 11 |
| 6 | perpendicular | 13 | 13 | 9 | 19 | 14 | 10 |
| 1 | parallel | 10 | 8 | 9 | 34 | 30 | 34 |
| 2 | parallel | 22 | 7 | 5 | 29 | 29 | 33 |
| 3 | parallel | 9 | 9 | 8 | 37 | 37 | 51 |
| 4 | parallel | 7 | 16 | 7 | 34 | 34 | 28 |
| 5 | parallel | 18 | 13 | 14 | 31 | 27 | 20 |
| 6 | parallel | 24 | 16 | 9 | 31 | 30 | 21 |

The results from table 6 give the ratios listed in table 7 of the gloss levels parallel to the direction of flow to the gloss levels perpendicularly to the direction of flow.

TABLE 7
Gloss level ratios and averaged gloss level ratio

| Measurement | | | | | | |
|---|---|---|---|---|---|---|
| point | A | B | C | D | E | F |
| 1 | 0.9 | 1.1 | 1.1 | 2.6 | 2.3 | 2.6 |
| 2 | 1.7 | 0.9 | 1.0 | 1.9 | 2.2 | 2.5 |
| 3 | 1.3 | 1.1 | 1.3 | 2.8 | 2.6 | 3.4 |
| 4 | 1.0 | 2.0 | 1.0 | 2.4 | 2.4 | 2.5 |
| 5 | 1.6 | 1.2 | 1.2 | 1.6 | 2.3 | 1.8 |
| 6 | 1.8 | 1.2 | 1.0 | 1.6 | 2.1 | 2.1 |
| Average | 1.5 | 1.3 | 1.1 | 2.1 | 2.3 | 2.6 |

The gloss level ratio averaged over the individual measurement points is the decisive factor for objective differentiation between the inventive and noninventive surface structure. Said ratio is stated in the last row of table 7.

From table 7 it can be seen that the averaged gloss level ratio for the moldings A-C produced in the invention is less than 1.9, in particular less than 1.5, and to some extent indeed less than 1.2, whereas the averaged gloss level ratios for the moldings D-F not produced in the invention are greater than 2, indeed in the present case greater than 2.1.

The criterion using the averaged gloss level ratios therefore permits objective differentiation between moldings of the invention and moldings not of the invention.

1.-18. (canceled)

19. A process for the production of a molding by structural foam molding, comprising
providing a plastics melt by melting of a thermoplastic,
loading the plastics melt with a blowing agent, and
injecting the plastics melt loaded with the blowing agent under pressure into a cavity of a mold in such a way that the plastics melt fills the cavity behind a melt front proceeding through the cavity,
wherein
the injection velocity at which the plastics melt is injected into the cavity of the mold is adjusted in such a way that, in a region that follows a section of the melt front with a chronological separation of at most 0.15 s, at least at one juncture during the injection procedure, the internal pressure of the plastics melt in the cavity is greater than the critical pressure of the blowing agent.

20. The process as claimed in claim 19, wherein the region in which the internal pressure of the plastics melt is, at least at one juncture during the injection procedure, greater than the critical pressure of the blowing agent follows the section of the melt front with a chronological separation of at most 0.1 s.

21. The process as claimed in claim 19, wherein the thermoplastic comprises a transparent plastic selected from the group consisting of polycarbonates (PC), polystyrenes (PS), polymethyl methacrylates (PMMA), styrene-acrylonitriles (SAN), cycloolefin copolymers (COC), transparent polyamides (PA), transparent polyesters, polyester made of terephthalic acid with cyclohexanedimethanol and tetramethylcyclobutanediol, and mixtures of these polymers.

22. The process as claimed in claim 19, wherein the thermoplastic is selected from the group consisting of polycarbonates (PC), polystyrenes (PS), polymethyl methacrylates (PMMA), cycloolefin copolymers (COC), styrene-acrylonitrile (SAN), transparent polyamides (PA), polyvinyl chlorides (PVC), polyphenylene ethers (PPE), and mixtures thereof.

23. The process as claimed in claim 19, wherein the plastics melt is loaded with a blowing agent via introduction of a gas into the plastics melt.

24. The process as claimed in claim 19, wherein the concentration of the blowing agent in the blowing-agent-loaded plastics melt before injection into the cavity is from 0.5 to 3% by weight for chemical blowing agents and from 0.2 to 1.0% by weight for physical blowing agents.

25. The process as claimed in claim 19, wherein the design of the mold is such that, in the direction of flow of the plastics melt, the cross section of the cavity does not narrow by more than 10%.

26. The process as claimed in claim 19, wherein the mold has been designed for a film gate or for a direct gate.

27. A molding made of a foamed thermoplastic, wherein
the molding has a surface region with optical structuring which is formed by the foamed thermoplastic and for which the averaged ratio of the gloss levels measured in the direction of flow to the gloss levels measured perpendicularly to the direction of flow is below 1.9.

28. The molding as claimed in claim 27, wherein the molding has been produced by structural foam molding.

29. The molding as claimed in claim 27, wherein the molding is produced by the process as claimed in claim 19.

30. The molding as claimed in claim 27, wherein the molding has a surface region with optical structuring which is formed by the foamed thermoplastic and for which the averaged ratio of the gloss levels measured in the direction of flow to the gloss levels measured perpendicularly to the direction of flow is below 1.5.

31. The molding as claimed in claim 27, wherein the molding has a surface region with optical structuring which is formed by the foamed thermoplastic and for which the averaged ratio of the gloss levels measured in the direction of flow to the gloss levels measured perpendicularly to the direction of flow is below 1.2.

32. The molding as claimed in claim 27, wherein the thermoplastic is a transparent plastic.

33. The molding as claimed in claim 27, wherein
the thermoplastic comprises a compound selected from the group consisting of polycarbonates (PC), polystyrenes (PS), polymethyl methacrylates (PMMA), styrene-acrylonitrile (SAN), transparent polyamides (PA), polyvinyl chlorides (PVC), polyphenylene ethers (PPE), and mixtures thereof.

34. The molding as claimed in claim 27, wherein the surface region with the optical structuring which is formed via the foamed thermoplastic comprises at least 30% the entire surface of the molding.

35. The molding as claimed in claim 27, wherein the thickness of the molding is in the range from 1 and 20 mm.

36. An article comprising the molding as claimed in claim 27, wherein the article is selected from the group consisting of an item of furniture or lighting elements, product casings, cups, bowls, protective covers, coolboxes, cladding parts for coolboxes, and multiple-use containers for refrigerated and fresh products.
